(19) United States
(12) Patent Application Publication
(10) Pub. No.: US 2012/0001052 A1
(43) Pub. Date: Jan. 5, 2012

(54) APPARATUS FOR HOLDING OR SUSPENDING VARIOUS ARTICLES FROM AN UPWARDLY FACING HORIZONTAL EDGE

(76) Inventor: ADIL ALIYEVICH ALIEV, Jefferson, MD (US)

(21) Appl. No.: 12/830,304

(22) Filed: Jul. 3, 2010

(51) Int. Cl. F16M 13/02

(52) U.S. Cl. 248/535; 248/220.22

(57) ABSTRACT

An apparatus for suspending articles from an upwardly facing horizontal edge having a bracket member and a clip member, where the two members are permanently or releasably attached. The bracket member preferably includes a generally flat inverted U-shaped portion to be placed over a door; the clip member includes first and second jaw portions extending from the hinge portion and a locking mechanism designed to deform the clip member from open to closed configuration. This invention offers solutions for manufacturing the apparatus from resilient or non-resilient material, although it is preferable that the clip member is made of resilient material, due to simplicity, economy of manufacture, and durability. The embodiments described in the invention are differ in the construction of their closing mechanism and the nature of the clip-bracket assembly, but it should also be understood that various combinations of features from different embodiments of this invention are also possible.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of clips and brackets and more specifically to an apparatus for holding or suspending various articles from an upwardly facing horizontal edge, such as over the door brackets and clips for holding sheet materials.

Over the door brackets are usually combined with hooks for hanging clothes and the like individually or in system of hooks; clips for sheet materials usually designed to suspend material from a rod, like curtains or hold the sheets of material down by tie down strings, like tarp clips.

There is a need though to be able to suspend a sheet material from a door or a frame without having to damage the material by making a hole in it and without having to damage the door by driving a nail into it or mounting a hook.
The present invention solves the problems of the prior art, by providing a device that allows to suspend an item without having to damage an item or a door.

### BRIEF SUMMARY OF THE INVENTION

The primary object of the invention is to provide an apparatus to grip and suspend various articles requiring suspended support from an upwardly facing horizontal edge on a support such as the top edge of a closet door.

Another object of the invention is to provide an apparatus to suspend various articles without damage to the underlying vertical surface such as a closet door, partition or frame.

Another object of the invention is to provide an apparatus to grip and suspend various articles that can be detachable from the bracket section and can be used independently from the bracket section.

A further object of the invention is to provide an apparatus to grip and support various articles that can be reversible, i.e. can hold items in suspended position and can hold rigid items up in upward position.

A further object of the invention is to provide an apparatus that allows controlled grip pressure on the suspended item.

Other objects and advantages of the present invention will become apparent from the following descriptions, taken in connection with the accompanying drawings, wherein, by way of illustration and example, an embodiment of the present invention is disclosed.

In accordance with the preferred embodiment of the invention, there is disclosed an apparatus for suspending various articles from an upwardly facing horizontal edge comprising a bracket-clip assembly for mounting on a horizontal edge and gripping an article requiring suspended support, comprising a bracket member which preferably includes a generally flat inverted U-shaped member adapted to be placed over a door, having three sides which meet at right angle, with middle horizontal portion and a first generally flat portion extending transversely from one end of the middle portion and serving as a base for clip attachment and a second generally flat portion transversely extending from the other end of the middle portion, a clip member attached to the first portion of the bracket, comprising a hinge portion, first and second jaw portions extending from the hinge portion, where the second jaw portion permanently or releasably attached to the first bracket portion, a mechanism to change the configuration of the clip member from open to closed, said clip member may be reversibly attached to the bracket member, in a way that the gripping jaws of the clip member may be facing up or down.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is an overview of the invention of ClipBracket assembly in assembled state.

FIG. 2 is an overview of the clip member of the invention without the bracket member.

FIG. 3 is a schematic diagram showing side view of the preferred embodiment of the invention (permanently attached bracket clip assembly).

FIG. 4 is a schematic diagram showing front view of the preferred embodiment invention

FIG. 5 is a schematic diagram showing back view of the preferred embodiment of the invention.

FIG. 6 is a schematic diagram showing crossectional view of the preferred embodiment of the invention with gripping jaws open.

FIG. 7 is a schematic diagram showing crossectional view of the preferred embodiment of the invention (gripping jaws closed) and illustrating the operation of the invention.

FIG. 8 is a schematic diagram of the preferred embodiment of the invention showing crossectional view and close up view of the closing/locking mechanism of the invention.

FIG. 9 is a schematic diagram illustrating the operation of a portion of the invention, namely closing the jaws by tightening the nut.

FIG. 10 is a schematic diagram illustrating the operation of the same portion of the invention, namely opening the jaws by unscrewing the nut.

FIG. 11 is a schematic diagram of another preferred embodiment of the invention showing the side and the back view of the detachable clip member.

FIG. 12 is a schematic diagram of the front and side view of the bracket of the detachable embodiment of the invention.

FIG. 13 is a schematic diagram showing the coupling nub of the bracket of the detachable clip-bracket embodiment of the invention.

FIG. 14 is a schematic diagram showing clip-bracket members in assembled state.

FIG. 15 is a schematic diagram of yet another preferred embodiment of the invention with detachable and reversible clip-bracket members assembly, showing the side and the back view of the Clip member.

FIG. 16 is a schematic diagram of the front and side view of the bracket of the detachable and reversible clip-bracket members embodiment of the invention.

FIG. 17 is a schematic diagram showing clip-bracket members in assembled state with the clip jaws facing downwards.

FIG. 18 is a schematic diagram showing clip-bracket members in assembled state with the clip jaws facing upwards.

FIG. 19 is a schematic diagram of yet another embodiment of the invention in which clip member has both jaws having grooves, which form a rounded notch when the jaws are clamped together to accommodate holding of rounded shaped objects.

FIG. 20 is a schematic diagram showing crossectional view of the embodiment of the invention in which clip member has both jaws having grooves, which form a rounded notch when clamped together to accommodate holding of rounded shaped objects.

FIG. 21 is a schematic diagram of yet another embodiment of the invention of the clip-bracket assembly, with a side ratchet locking mechanism.

FIG. 22 is a schematic diagram of the clip-bracket assembly, with the side ratchet locking mechanism embodiment of the invention illustrating the operation of the ratchet lock and slider, where locking lever is engaged.

FIG. 23 is a schematic diagram of the clip-bracket assembly, with the side ratchet locking mechanism embodiment of the invention illustrating the operation of the ratchet lock and slider, where locking lever is disengaged.

FIG. 24 is a schematic diagram of yet another embodiment of the invention of the clip-bracket assembly, with a front ratchet locking mechanism, where a part of the slider is cut-off to show the front ratchet on the clip member.

FIG. 25 is a cross section diagram of the clip-bracket assembly, with the front ratchet locking mechanism embodiment of the invention illustrating the operation of the ratchet lock and slider, where locking lever is engaged.

FIG. 26 is a cross section diagram of the clip-bracket assembly, with the front ratchet locking mechanism embodiment of the invention illustrating the operation of the ratchet lock and slider, where locking lever is disengaged.

FIG. 27 is a schematic diagram of yet another embodiment of the invention of the clip-bracket members assembly, with an internal ratchet locking mechanism.

FIG. 28 is a front view diagram of the clip-bracket assembly, of the internal ratchet embodiment of the invention.

FIG. 29 is a cross section diagram of the clip-bracket assembly, of the internal ratchet embodiment of the invention illustrating the operation of the invention, where internal ratchet is engaged.

FIG. 30 is a cross section diagram of the clip-bracket assembly, of the internal ratchet embodiment of the invention illustrating the operation of the invention, where internal ratchet is disengaged.

FIG. 31 is a schematic diagram illustrating the operation of the invention providing upward support of an item with rounded shape, like a small flagpole, on an upwardly facing horizontal edge.

FIG. 32 is a schematic diagram illustrating the operation of the invention as a holder of an item requiring suspended support from an upwardly facing horizontal edge

FIG. 33 is a schematic diagram illustrating the use of the invention for suspending of a sheet material.

FIG. 34 is a schematic diagram illustrating the use of the invention as a basketball basket holder.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

### DETAILED DESCRIPTION OF THE INVENTION

The present invention may be made in different embodiments, a number of these embodiments will be described below, but it is obvious and should also be understood that various combinations of featured portions from different embodiments of this invention are also possible.

### Overview.

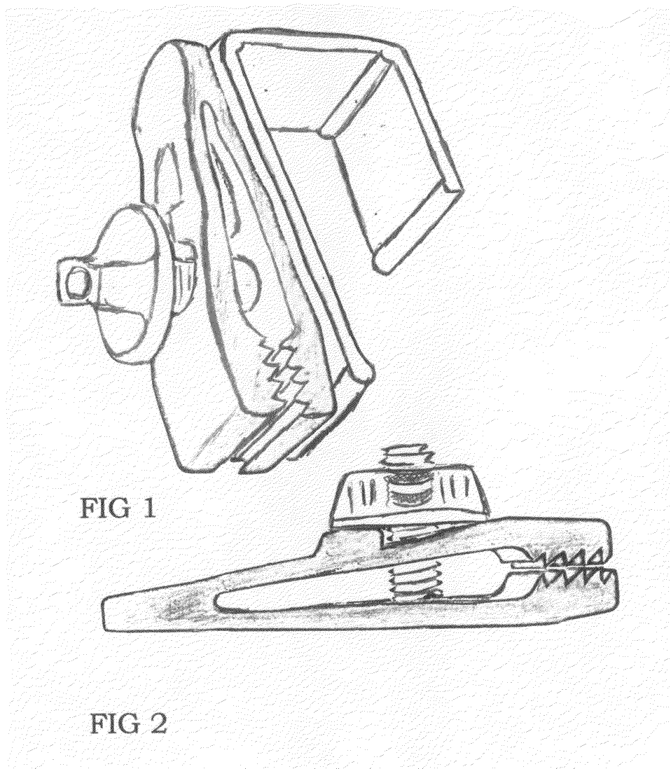

Referring initially to FIGS. 1-2 depicted therein is a general overview of preferred embodiment of a clip-bracket assembly in assembled state FIG. 1 and clip member only FIG. 2.
Although the clip-bracket assembly may be formed of any suitable material, it is generally preferable that the clip member is made of resilient material such as the clip member may be deformed from a normally open configuration into a closed position.
Such material is highly advantageous from the standpoint of simplicity, economy of manufacture, and durability, also that there are only one or two separate parts in the final assembly.
In general all embodiments described below differ in the construction of their closing mechanism and the nature of the clip-bracket assembly.

### Structure and Operations

### Preferred Embodiments

### A. Permanently Attached Clip-Bracket Assembly

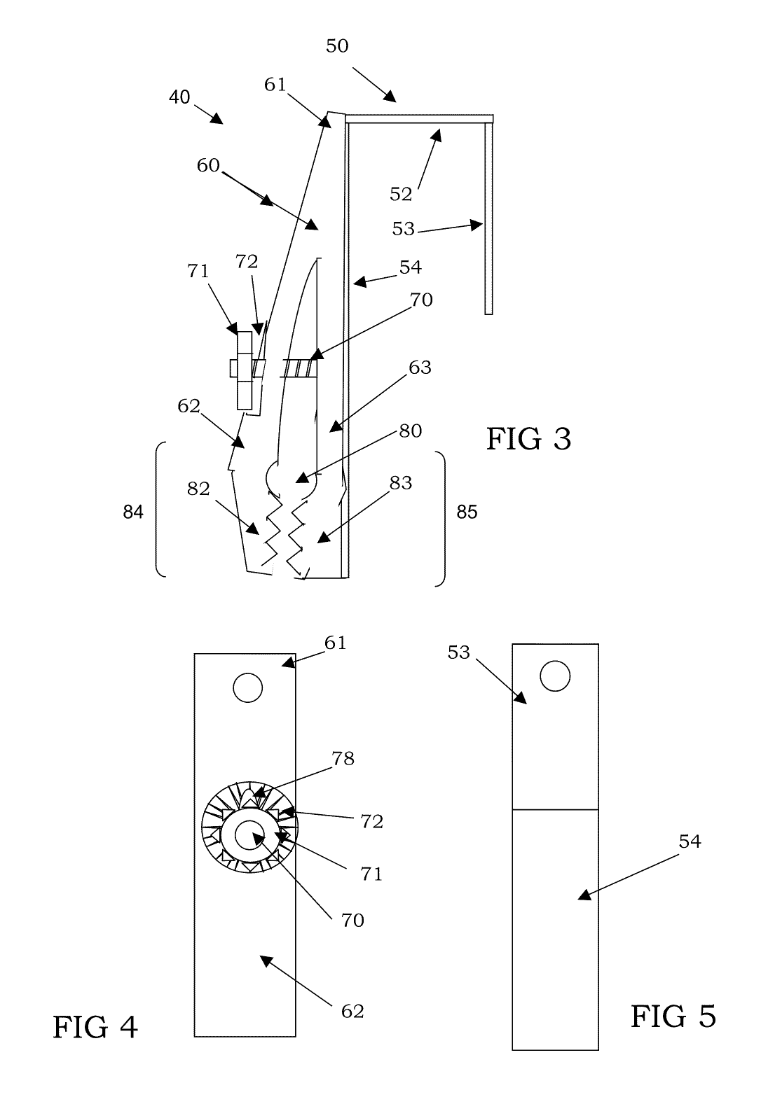

Referring now to FIGS. 3-7 depicted therein is a permanently attached embodiment of a clip-bracket assembly 40 constructed in accordance with and embodying the principles of the present invention. The clip-bracket assembly 40 comprises a clip member 60 and a Bracket member 50.
The clip member 60 defines first and second jaws 62 and 63 connected by a hinge portion 61. The clip-bracket assembly 40 is molded from a single piece of plastic such that the jaws 62 and 63 extend from the hinge portion 61. Where the back side of the second gripping jaw 63 is in effect serves as the first portion of the bracket member 54, and the median over the door traverse portion of the bracket 52 extends from the same hinge portion 61. The second portion 53 of the bracket member extends from the traverse portion 52 at right angle or slightly less to provide for some gripping action. The first portion 54 and the second portion 53 are separated by a first distance, which corresponds generally to the thickness of a door over which the bracket is to be placed.
Without the application of external forces on the jaws 62 and 63 these jaws are spaced from each other in an open or unclamped configuration as shown in FIG. 3. However, the material from which the clip member 60 is made is sufficiently flexible to allow the jaw members to be forced towards each other into a clamped configuration as shown in FIG. 7. The first jaw 62 defines a first gripping portion 84, flattened platform 72 that may carry ratcheted design for better grip in clamped configuration, and opening 78.
The second jaw 63 defines a second gripping portion 85 and the rounded protrusion 70 with thread that matches thread on the locking nut 71.
Each of the gripping portions 84 and 85, comprise a plurality of gripping teeth 82 and 83.

A closing mechanism to force the jaws 62 and 63 into a closed configuration comprises a nut 71 and the threaded protrusion 70 from the second jaw 63 working similar to nut and bolt action.

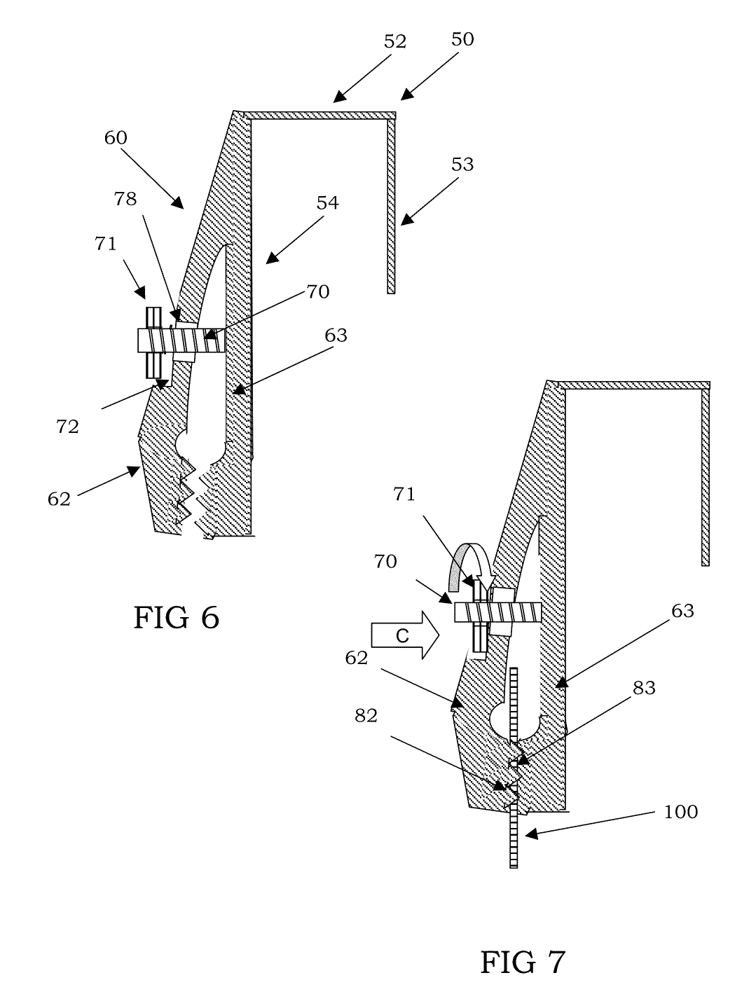

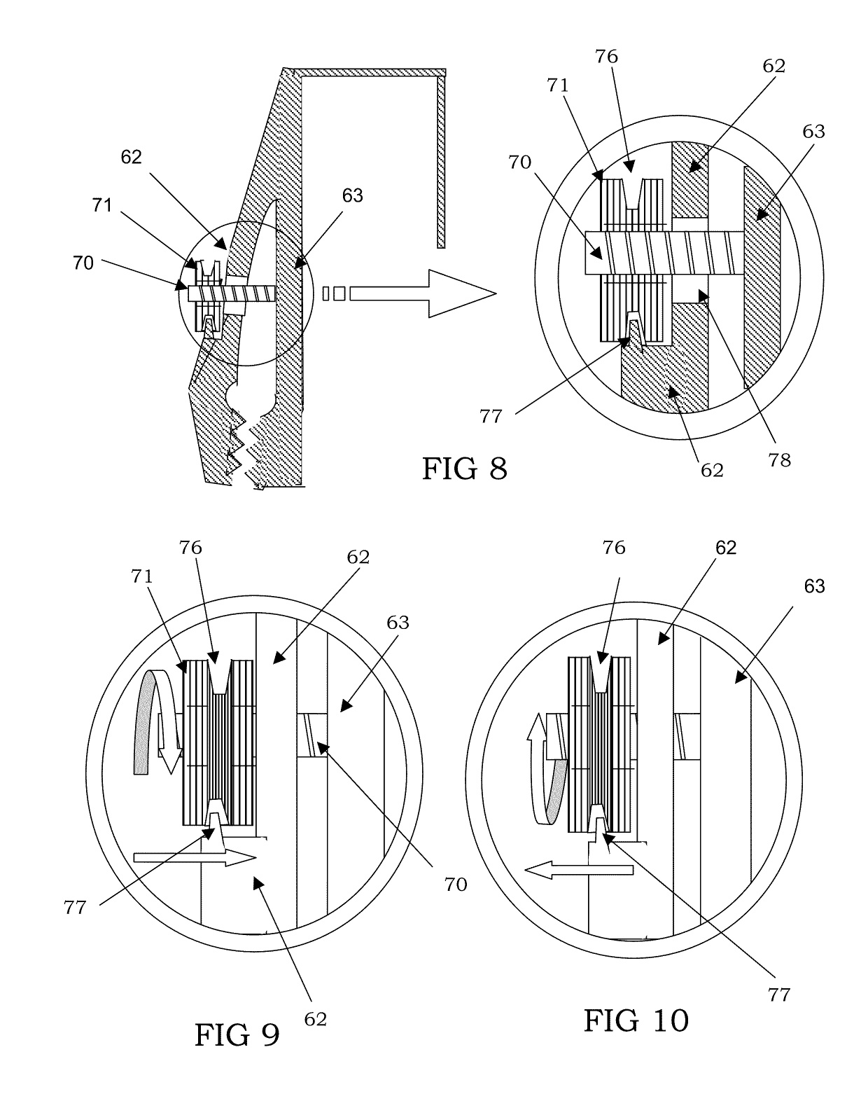

The locking nut member 71 is fitted on the threaded protrusion 70 of the second gripping jaw portion 63 and moves on/along the threaded protrusion 70 between clamped and unclamped positions. When the locking nut member 71 is in the unclamped position as shown in FIG. 6, the jaws 62 and 63 are in the open configuration. When the locking nut member 71 is in the clamped position as shown in FIG. 7, the jaws 62 and 63 are forced towards each other such that the clip member 60 is in its clamped configuration. This closing mechanism is advantageous because it provides a controlled grip force on the suspended item 100.
FIGS. 8-10 show an additional embodiment of the present invention with enhancement features, that would make this invention work even if the clip is made out of non-resilient material. The above mentioned enhancement comprises of a lip protrusion 77 extending from the gripping portion 84 of the first jaw 62 and a circular groove 76 on the edge of the locking nut 71. Although the clip 60 if made out of resilient material does not require this additional embodiment feature, this also may be advantageous to keep jaws open larger than normal, where without this enhancement the jaws have to be forced apart manually if the item requiring suspension is larger than the normal opening of the jaws in the unclamped configuration.

### B. Detachable Clip-Bracket Assembly

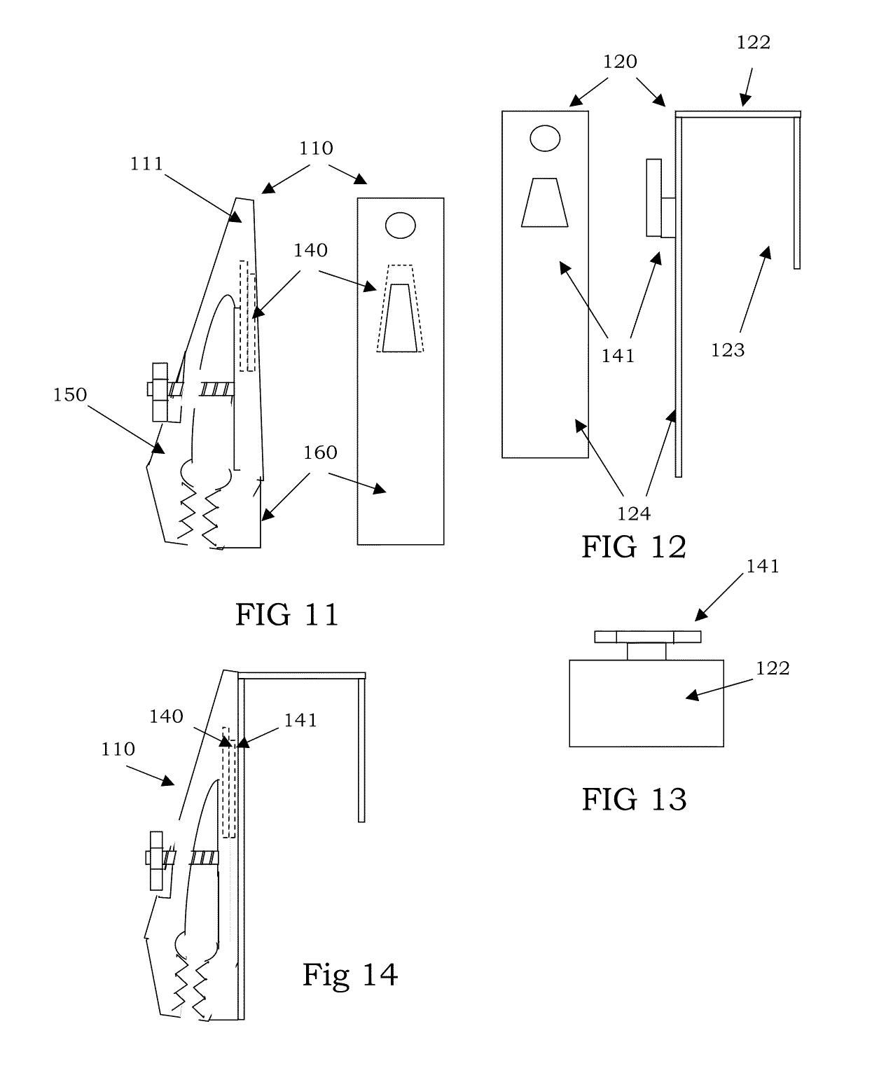

Referring now to FIGS. 11-14 depicted therein is a detachable embodiment of a clip-bracket assembly constructed in accordance with and embodying the principles of the present invention. This clip-bracket assembly comprises a clip member 110 and a separate bracket member 120, which are basically have the same structural elements as previously described embodiment, except that first bracket portion 124 is not attached to second jaw portion 160.
Since the clip 110 mostly comprised of the same elements as in the previously described embodiment we will only address structural elements that make this current embodiment detachable.
The bracket member 120 is a U-shaped bracket comprising a median over the door traverse portion 122 and first and second portions 124 and 123 attached to the median portion 122. The first and second portions are separated by a first distance, which corresponds generally to the thickness of a door over which the bracket is to be placed.
A nub 141 protrudes from the first portion 124 on its side to be facing the clip member as shown in FIGS. 12 and 13 for coupling with the clip member 110.
FIG. 11 shows the clip member 110 with the jaws 150 and 160 extending from the hinge portion 111. The second jaw 160 has an opening 140 shaped to accommodate coupling with the nub 141 (shown on FIG. 12 and FIG. 13) in a way that the nub 141 fits into the opening 140 and securely locks in place as shown in FIG. 14.
The nub 141 and opening/recess 140 are positioned in such a way that in assembled state, the hinge portion 111 of the clip 110 does not extend over the median portion 122 of the bracket 120.

### Additional Embodiments

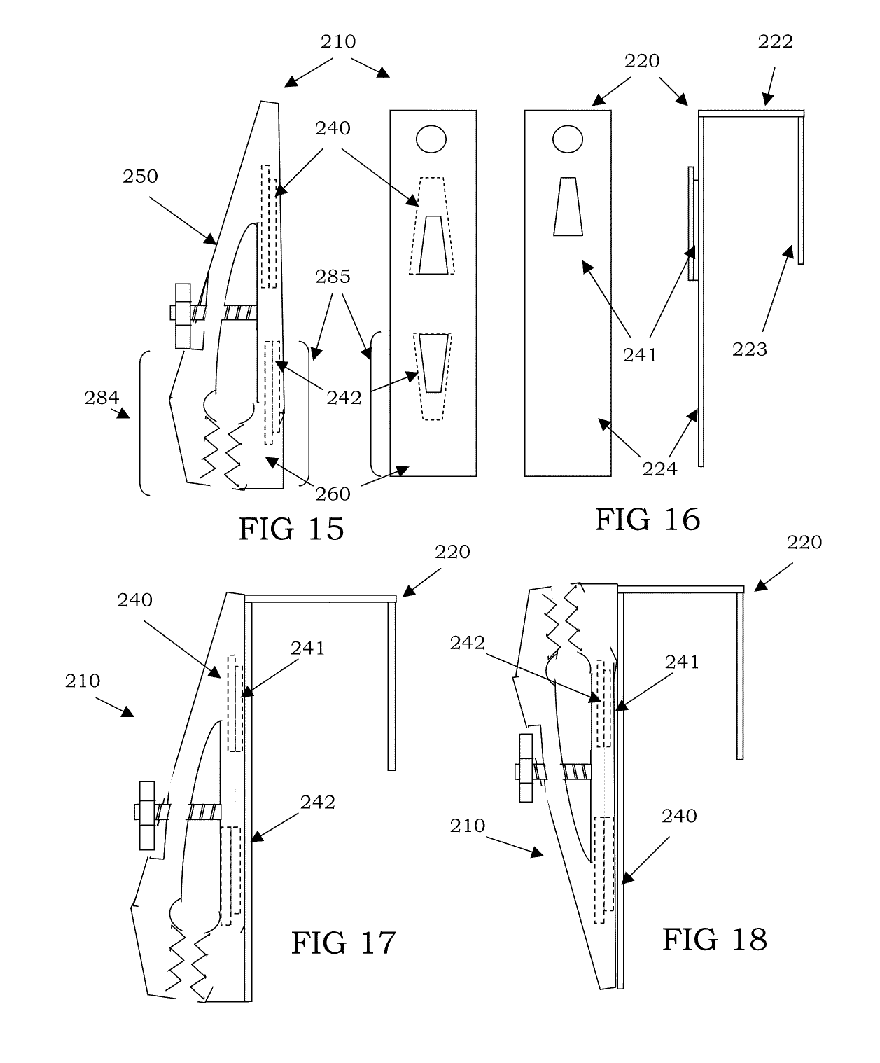

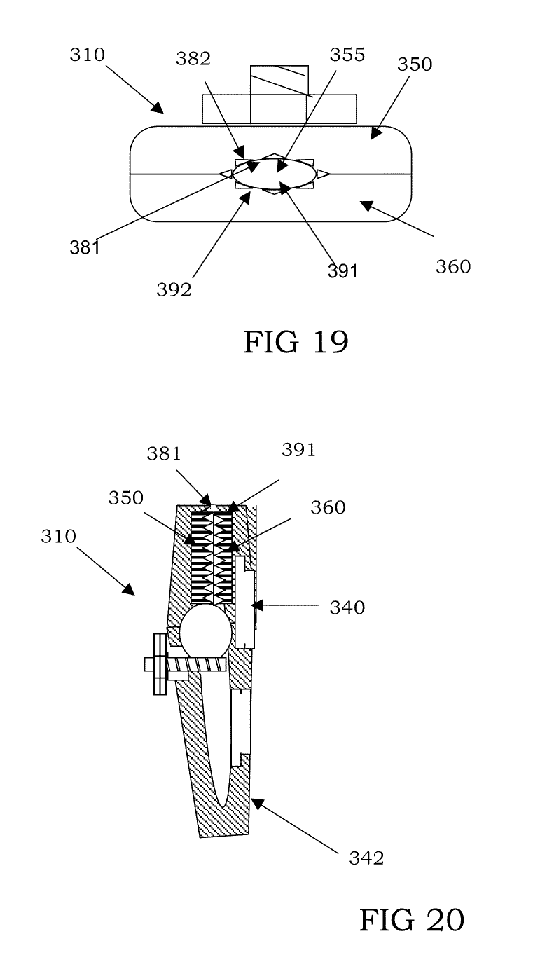

Referring now to FIGS. 15-18 depicted therein is a detachable and reversible embodiment of a clip-bracket assembly constructed in accordance with and embodying the principles of the present invention. This embodiment differs from previously described detachable clip-bracket assembly by the additional opening/recess 242 in the clip member 210. The bracket member 220 is the same as the previously described bracket member 120.
The said additional opening/recess 242 shaped as a mirror-like reflection of the opening recess 240, and when the clip is reversed it matches the shape of nub 241 for male/female type coupling. The opening/recess 242 is positioned on the gripping portion 285 in a way that when the clip-bracket assembly is in assembled state jaws 250 and 260 do not extend over the median portion 222 of the bracket 220 as shown in FIGS. 17 and 18.
Referring now to FIGS. 19-20 depicted therein is an embodiment feature designed to facilitate holding of the rounded objects, such as flagpole, to prevent them from skewing from side to side when held vertically. The said embodiment comprises
first groove 381 with plurality of gripping teeth 382 in the first jaw 350 and the second groove 391 with plurality of gripping teeth 392 in the second gripping jaw 360. when two jaw are in the closed state the grooves 381 and 392 form an expansion slot 355 that facilitates holding rounded objects vertically.

### Side Ratchet Embodiment

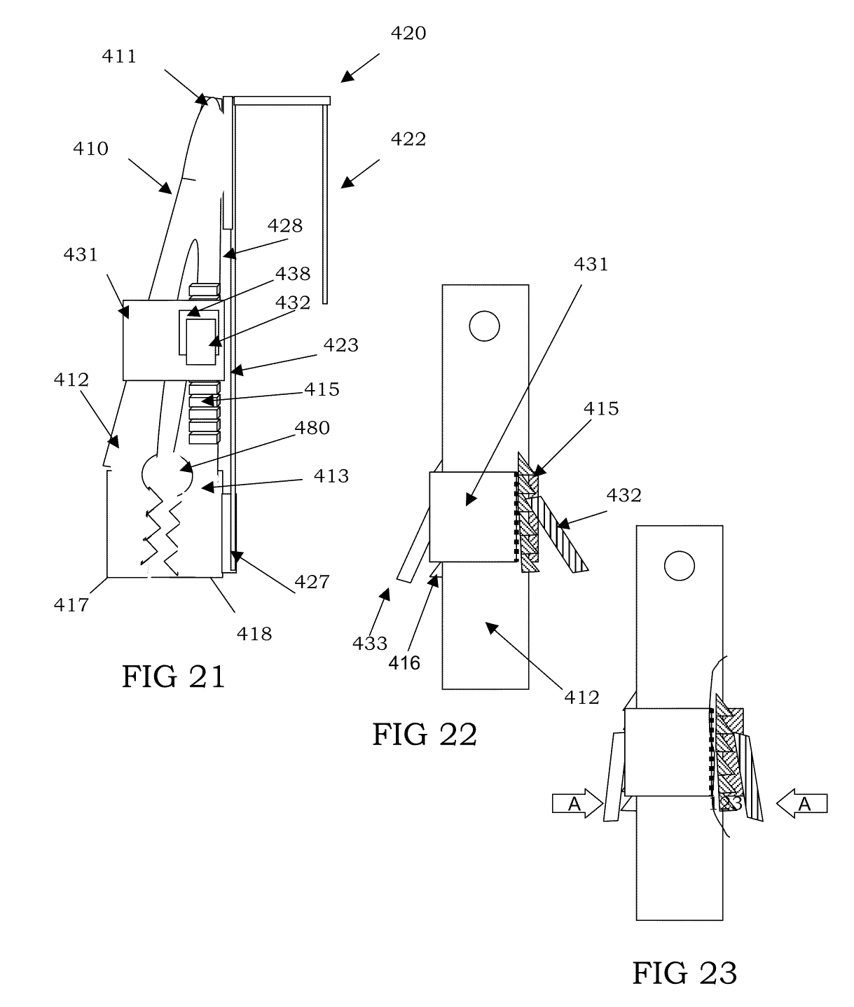

Referring now to FIGS. 21-23 depicted therein is another embodiment of a clip-bracket assembly of the present invention. This embodiment differs from previously described embodiments by closing/locking mechanism comprising a sliding member 431 and side ratchets 415 and 416 on the second jaw 413. The sliding member 431 slides between clamped and unclamped positions relative to the clip member 410. When the sliding member 431 is in the unclamped position as shown in FIG. 21, the jaws 412 and 413 are in the open configuration. When the sliding member 431 is in the clamped position as shown in FIG. 22 the levers 432 and 433 engage with the ratchets 415 and 416 to hold the slider and keep the clip in the locked configuration. Applying pressure on the levers 432 and 433 disengages from the ratchet teeth 415 and can be moved to change clip into unclamped configuration.
The bracket member 420 may also be permanently attached or detachable. FIG. 421 shows embodiment of the present invention with permanently attached Clip-Bracket assembly. First bracket portion 423 extends from the hinge portion 411 of the clip member 410 along and parallel to the second jaw 413 of the clip member 423 and forming a slot 428 between Second jaw 413 and lower portion of the first bracket portion 423 allowing for the movement of the sliding member 431. At the end of first bracket portion 423 there is a lip 427, which is in normal position touching the jaw 413 and works as a stoppage for the sliding member 431, preventing it from sliding off of the clip member 410.

### Front Ratchet Embodiment

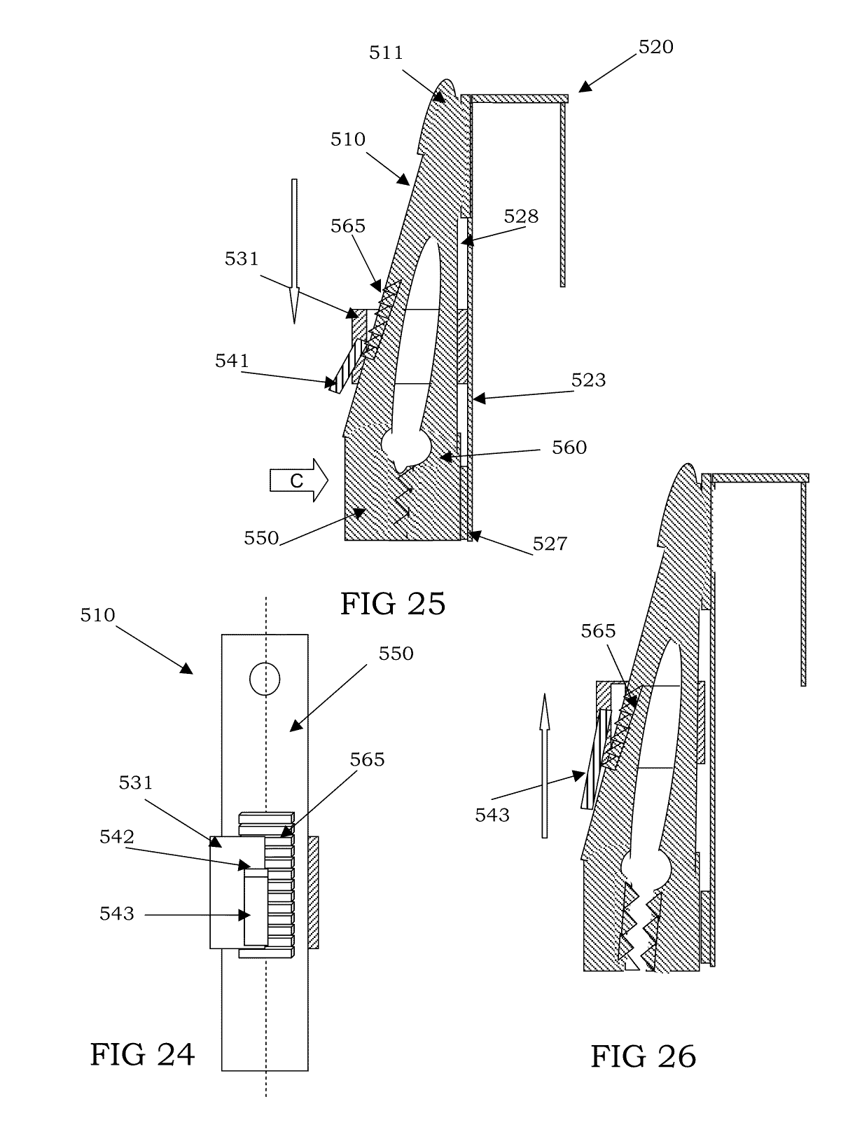

Referring now to FIGS. 24-26 depicted therein is another embodiment of a clip-bracket assembly of the present invention. This embodiment differs from previously described embodiments by closing/locking mechanism comprising a sliding member 531 and front ratchet 565 on the first jaw 565 of the clip 510 as shown in FIG. 24.
The sliding member 531 slides between clamped and unclamped positions relative to the clip member 510. When the sliding member 531 is in the clamped position as shown in FIG. 25, the jaws 550 and 560 are in the closed configuration. Lever 541 is engaged with ratchet 565 to lock sliding member 531 in this position. When the lever 541 pressed it disengages from front ratchet 565 and the sliding member 531 can be moved in the unclamped position as shown in FIG. 26.

### Internal Ratchet Embodiment

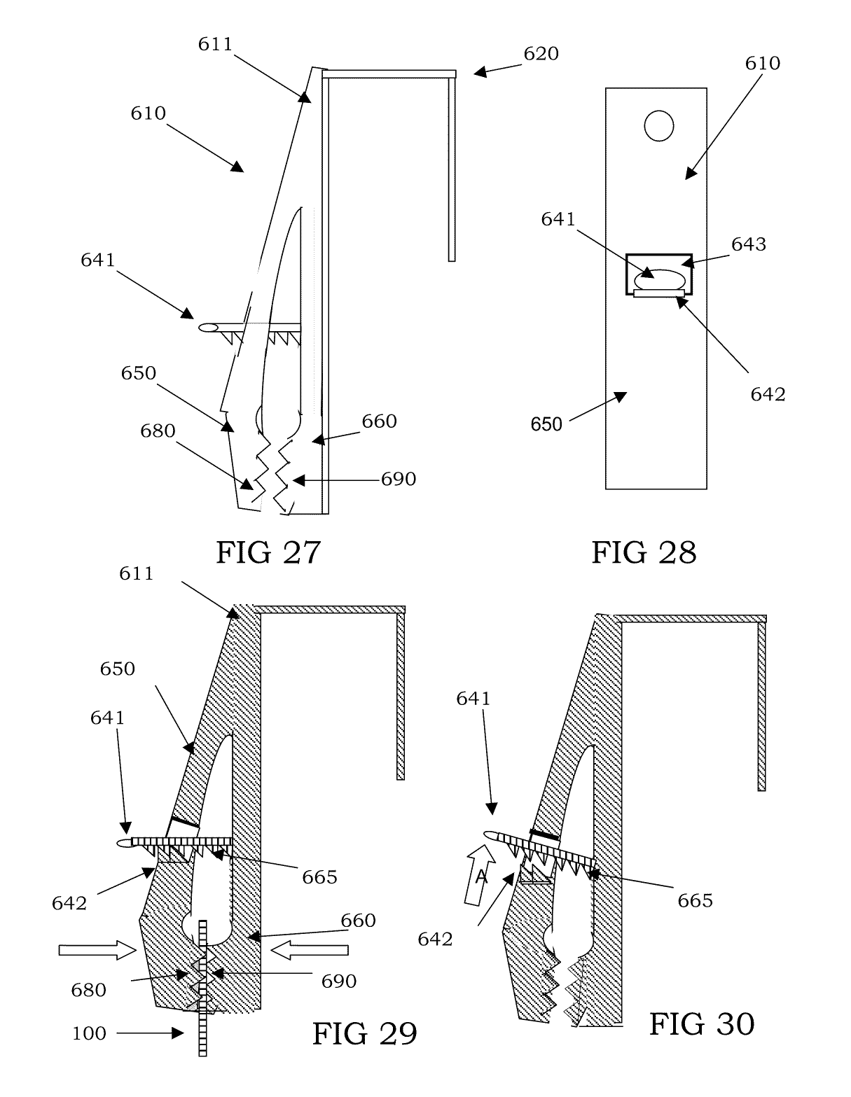

Referring now to FIGS. 27-30 depicted therein is yet another embodiment of a clip-bracket assembly constructed in accordance with and embodying the principles of the present invention. In this embodiment internal ratchet portion 665 is used to hold the clip 610 in closed configuration. Clip 610 may be permanently or detachably connected to bracket 620. Bracket construction was described earlier in detailed descriptions of previous embodiments.
The clip member 610 defines first and second jaws 650 and 660 connected by a hinge portion 611. The clip-bracket assembly 610 is molded from a single piece of plastic such that the jaws 650 and 660 extend from the hinge portion 611. The first gripping jaw 650 comprises an opening 643 with set of locking teeth 642. The second gripping jaw has an internal ratchet protrusion 641 with set of ratchet teeth 665. Said protrusion 665 is fitted through opening 643 in a way that set of ratchet teeth 665 faces set of locking teeth 642.
Without application of external forces on the jaws 650 and 660 these jaws are spaced from each other in an open or unclamped configuration as shown in FIG. 27. However, the material from which the clip member 610 is made is sufficiently flexible to allow the jaw portions to be forced towards each other into a clamped configuration as shown in FIG. 29 by applying a force directly on the jaws 650 and 660.
The set of ratchet teeth 665 of the internal ratchet 641 then engages with set of locking teeth 642 of the first gripping jaw 650 locking the clip member 610 in a clumped configuration. Since the internal ratchet 641 is made out of the same resilient material as the clip 610 and it is sufficiently flexible to be pushed out of the engagement when a direct force applied to the tip of the internal ratchet 641 in the direction opposite to the locking teeth 642. Once the set of ratchet teeth 665 disengages from the locking teeth 642 the clip 610 returns in its unclamped configuration.

### Use Examples

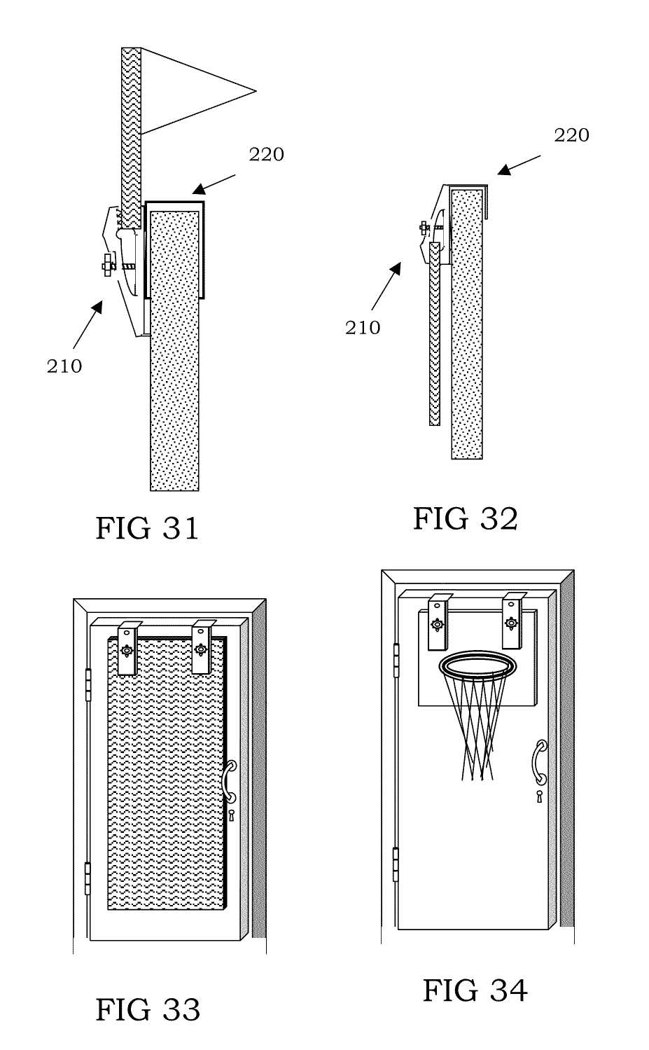

Referring now to FIGS. 31-34 depicted therein are examples of use of the present invention: detachable reversible embodiment holding a Flag vertically upwards;
Suspended support of a sound blanket or insulating blanket over the door FIG. 33,
Suspended support of a basketball basket FIG. 34.

While the invention has been described in connection with the preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

A. An apparatus for suspending various articles from an upwardly facing horizontal edge comprising:
a permanently attached bracket-clip assembly for mounting on an upwardly facing horizontal edge and gripping an article requiring suspended support; comprising
a bracket member which preferably includes a generally flat inverted U-shaped portion adapted to be placed over a door, having three sides which meet at right angle, with middle horizontal portion and a first generally flat portion extending traversely from one end of the middle portion and permanently attached to a second jaw of the clip and a second generally flat portion transversely extending from the other end of the middle portion;
a clip member permanently attached to the first portion of the bracket, comprising
a hinge portion, first and second jaw portions extending from the hinge portion, where the second jaw portion is permanently attached to the first bracket portion;
and means to change the configuration of the clip member from open to closed.
A-1. An apparatus for suspending various articles from an upwardly facing horizontal edge as claimed in claim A wherein
said clip member can be made out of non-resilient material;
said clip member can be made out of resilient material, so that it is normally forming an open configuration, where the first and second jaws do not engage each other and can be deformed into a closed configuration by applying inward pressure on the jaws and therefore engaging the jaws;
A-2. The clip member as claimed in claim A further comprising at least one protrusion from the second jaw and an opening in the first jaw matching the said protrusion of the second jaw;
wherein the said opening in the first jaw is of sufficient size to allow free movement of the first jaw along the protrusion of the second jaw;
wherein the said protrusion of the second jaw has a thread on it to receive a locking nut;
said clip member further comprising a nut member that can be screwed on the thread of the said protrusion;
wherein when the said nut is screwed down, it applies a force that changes configuration of the jaws from open to closed, and when the nut is unscrewed it allows the first jaw to return into the open configuration;
A-3. The clip member as claimed in claim A further comprising at least one protrusion from the second jaw and an opening in the first jaw matching the said protrusion of the second jaw;
wherein the said opening in the first jaw is of sufficient size to allow free movement of the first jaw along the protrusion of the second jaw;
wherein the said protrusion of the second jaw has a thread on it to receive a locking nut;
wherein the first jaw further comprising a protrusion or lip on it to match the groove on the locking nut member, that in assembled configuration fits into the groove of the said locking nut member;
said clip member further comprising a nut member that can be screwed on the said thread of the protrusion;
the nut member further comprising a groove along its edge to receive a lip from the first jaw;
wherein when the nut is screwed down it applies an inward force on the said lip of the first jaw that changes configuration of the jaws from open to closed and when the nut is unscrewed it applies an outward force on the first jaw lip to change it into the open configuration;
A-4. An apparatus for suspending various articles from an upwardly facing horizontal edge as claimed in claim A further comprising the bracket member, that is permanently attached to the clip member at the upper portion of the clip member and extends down from the attachment until bottom end of the clip member free from the second jaw portion to form a guiding slot for a sliding member of the clip member;
said extension of the bracket member, having at the free end of the extension a projection towards the clip member to serve as a stoppage for the sliding member of the clip member;
A-5. The clip member as claimed in claim A further alternatively comprising at least one ratchet system of teeth on at least one surface of the clip;
A-6. The clip member as claimed in claim A-5 further comprising a sliding member, that is encircles both jaw portions of the clip member like a collar and moving freely in the slot between the clip member and the bracket extension as defined on the claim A-4.
said sliding member when positioned at the upper portion of the slot allows the jaws to remain in the default open configuration, and when moved towards the bottom of the clip said sliding member acts on the jaws forcing them into closed configuration;
A-7. The sliding member as claimed in claim A-6 further comprising a latching mechanism to engage with ratchet system on the clip member to lock the clip in the closed configuration;
wherein at least one said latching mechanism to be located on the front of the sliding member;
wherein at least one said latching mechanism to be located on one or both sides of the sliding member;
A-8. The clip member as claimed in claim A further alternatively comprising at least one protrusion from the second jaw portion made with resilient material and an opening in the first jaw portion matching location of the said protrusion of the second jaw portion;
wherein said protrusion carries a set of ratchet teeth and is in normal configuration engaged with at least one latching tooth on the edge of the said opening in the first jaw;
wherein said opening in the first jaw is of sufficient size to allow for ratchet set of the protrusion to be disengaged from the latching tooth of the opening edge;
wherein applying a force to the said protrusion would disengage the ratchet teeth of the protrusion from the latching tooth of the first jaw allowing for jaws to disengage and return to open configuration;

B. What also claimed is: a detachable apparatus for suspending various articles from an upwardly facing horizontal edge comprising:
a detachable clip and bracket assembly members for mounting on an upwardly facing horizontal edge and gripping an article requiring suspended support;
further comprising
the bracket member which preferably includes a generally flat inverted U-shaped member adapted to be placed over a door, having three sides which meet at right angle, with middle horizontal portion and a first generally flat portion extending traversely from one end of the middle portion and serving as a base for clip attachment and a second generally flat portion transversely extending from the other end of the middle portion;
whereby the first portion of a bracket member has at least one coupling nub for detachably connecting to the clip member'
the clip member, comprising
a hinge portion, first and second jaw portions extending from the hinge portion, where second jaw portion has an opening or recessed portion matching the shape of coupling nub of the first portion of the bracket member and designed to receive the said coupling nub in male-female type connection;
B-1. An apparatus for suspending various articles from an upwardly facing horizontal edge as claimed in claim B further comprising the bracket member, having a mechanism for coupling with the clip member as male-female connection;
wherein said coupling mechanism is a nub shaped to match the opening or recessed portion in the clip member,
wherein said coupling nub made in a pivotal or other suitable configuration where the clip has to be turned or slid in somewhat in order to hook and lock on the bracket nub;
B-2. An apparatus for suspending various articles from an upwardly facing horizontal edge as claimed in claim B wherein
said clip member can be made out of non-resilient material
said clip member can be made out of resilient material so that it is normally forming an open configuration, where the first and second jaw portions do not engage each other and can be deformed into a closed configuration by applying inward pressure on the jaws and therefore engaging the jaws;
B-3. The clip member as claimed in claim B further comprising at least one protrusion from the second jaw portion and an opening in the first jaw portion matching the said protrusion of the second jaw portion;
wherein the said opening in the first jaw portion is of sufficient size to allow free movement of the first jaw portion along the protrusion of the second jaw portion;
wherein the said protrusion of the second jaw portion has a thread to receive a locking nut;
said clip member further comprising a nut member that can be screwed on the thread of the said protrusion;
wherein when the nut is screwed down it applies a force that changes configuration of the jaws from open to closed and when the nut is unscrewed it allows the first jaw portion to return into the open configuration;
B-4. The clip member as claimed in claim B further comprising at least one protrusion from the second jaw portion and an opening in the first jaw portion matching the said protrusion of the second jaw portion;
wherein the said opening in the first jaw portion is of sufficient size to allow free movement of the first jaw portion along the protrusion of the second jaw portion;
wherein the said protrusion of the second jaw portion has a thread on it to receive a locking nut member;
wherein the locking nut member can be screwed on the said thread of the protrusion;
the locking nut member further comprising a groove around its edge to receive a lip of the first jaw portion of the clip member;
wherein the first jaw further comprising a protrusion or a lip on it to match the groove on the locking nut member,
wherein the said lip in assembled configuration fits into the groove of the said locking nut member;
wherein when the nut is screwed down it applies an inward force on the said lip of the first jaw that changes configuration of the jaws from open to closed and when the nut is unscrewed it applies an outward force on the said lip to change clip jaws into the open configuration
B-5. The clip member as claimed in claim B further alternatively comprising at least one ratchet system of teeth on at least one surface of the clip;
B-6. The clip member as claimed in claim B-5 further comprising a sliding member, that encircles both jaw portion of the clip member like a collar;
said sliding member when positioned at the upper portion of the slot allows the jaw portions to remain in the default open configuration, and when moved towards the bottom of the clip, said sliding member acts on the jaws forcing them into closed configuration;
B-7. the sliding member as claimed in claim B-4 further comprising a latching mechanism to engage with ratchet system on the clip member to lock the clip in the closed configuration;
wherein at least one said latching mechanism to be located on the front of the sliding member;
wherein at least one said latching mechanism to be located on one or both sides of the sliding member;
B-8. The clip member as claimed in claim B further alternatively comprising at least one protrusion from the second jaw portion made with resilient material and an opening in the first jaw portion matching location of the said protrusion of the second jaw portion;
wherein said protrusion carries a set of ratchet teeth and is in normal configuration engaged with at least one latching tooth on the edge of the said opening in the first jaw portion;
wherein said opening in the first jaw portion is of sufficient size to allow for ratchet set of the protrusion to be disengaged from the latching tooth of the opening edge;
wherein applying a outward force to the said protrusion would disengage the ratchet teeth of the protrusion from the latching tooth of the first jaw allowing for jaws to disengage and return to open configuration;

C. What also claimed is a detachable and reversible apparatus for suspending or holding up various articles from an upwardly facing horizontal edge, comprising:
a detachable and reversible clip and bracket assembly members for mounting on a upwardly facing horizontal edge and gripping an article requiring hold or suspended support; comprising
a bracket member which preferably includes a generally flat inverted U-shaped member adapted to be placed over a door, having three sides which meet at right angle, with middle horizontal portion and a first generally flat portion extending transversely from one end of the middle portion and serving as a base for a clip attachment and a second generally flat portion transversely extending from the other end of the middle portion;
the bracket member further comprising a coupling nub for detachable connection to the clip member;
a clip member, comprising
a hinge portion, first and second jaw portions extending from the hinge portion, where second jaw portion in the preferred embodiment has two openings and or recessed portions both matching the shape of coupling nub of the first portion of the bracket for male-female type connection and positioned on the clip along the outwards facing portion of second jaw in a mirror like fashion;
C-1. An apparatus for suspending or holding up various articles from an upwardly facing horizontal edge as claimed in claim C further comprising the bracket member, having a mechanism for coupling with the clip member;
wherein said coupling mechanism is a nub shaped to match the recessed portion in the clip member;
wherein said coupling nub made in a pivotal or other suitable configuration where the clip has to be turned or slid on somewhat in order to hook and lock on the bracket nub;
C-2. An detachable and reversible apparatus for suspending or holding up various articles from an upwardly facing horizontal edge as claimed in claim C wherein
said clip member can be made out of non-resilient material
said clip member can be made out of resilient material so that it is normally forming an open configuration, where the first and second jaw portions do not engage each other and can be deformed into a closed configuration by applying inward pressure on the jaw portions and therefore engaging the gripping teeth;
C-3. The clip member as claimed in claim C further comprising at least one protrusion from the second jaw portion and an opening in the first jaw portion matching the said protrusion of the second jaw portion;
wherein the said opening in the first jaw portion is of sufficient size to allow free movement of the first jaw portion along the protrusion of the second jaw portion;
wherein the said protrusion of the second jaw portion has a thread on it to receive a locking nut member;
wherein a nut member can be screwed on the thread of the said protrusion;
wherein when the nut is screwed down it applies a force that changes configuration of the jaws from open to closed and when the nut is unscrewed it allows the first jaw to return into the open configuration;
C-4. The clip member as claimed in claim C further comprising at least one protrusion from the second jaw portion and an opening in the first jaw portion matching the said protrusion of the second jaw portion;
wherein the said opening in the first jaw portion is of sufficient size to allow free movement of the first jaw portion along the protrusion of the second jaw portion;
wherein the said protrusion of the second jaw portion has a thread on it to receive a locking nut member;
said clip member further comprising the locking nut member that can be screwed on the thread of the said protrusion;
the locking nut member further comprising a groove around its edge to receive a lip of the first jaw portion;
wherein the first jaw further comprising a protrusion or a lip on it to match the groove on the locking nut member,
wherein the said lip in assembled configuration fits into the groove of the said locking nut member;
wherein when the nut is screwed down it applies an inward force on the said lip of the first jaw that changes configuration of the jaws from open to closed and when the nut is unscrewed it applies an outward force on the said lip to change clip jaws into the open configuration;
C-5. The clip member as claimed in claim C further alternatively comprising at least one ratchet system of teeth on at least one surface of the clip;
C-6. The clip member as claimed in claim C-5 further comprising a sliding member, that encircles both jaws of the clip member like a collar;
said sliding member when positioned at the upper portion of the slot allows the jaws to remain in the default open configuration, and when moved towards the bottom of the clip, said sliding member acts on the jaws forcing them into closed configuration;
C-7. The sliding member as claimed in claim C-6 further comprising a latching mechanism to engage with ratchet system on the clip member to lock the clip in the closed configuration;
wherein at least one of said latching mechanism to be located on the front of the sliding member;
wherein at least one of said latching mechanism to be located on one or both sides of the sliding member;
C-8. The clip member as claimed in claim C further alternatively comprising at least one protrusion from the second jaw portion made with resilient material and an opening in the first jaw portion matching location of the said protrusion of the second jaw portion;
wherein said protrusion carries a set of ratchet teeth and is in normal configuration engaged with at least one latching tooth on the edge of the said opening in the first jaw portion;
wherein said opening in the first jaw portion is of sufficient size to allow for ratchet set of the protrusion to be disengaged from the latching teeth of the opening edge;
wherein applying a outward force to the said protrusion would disengage the ratchet teeth of the protrusion from the latching tooth of the first jaw portion allowing for jaw portions to disengage and return to open configuration;
C-9. The clip member as claimed in claim C further comprising at least one groove on each of the gripping portions of the first and second jaw portions facing each other in matching locations,
wherein said groove is deeper than the gripping teeth of the gripping portion of the first and second jaw portions;
wherein said groove has gripping teeth of its own positioned in a direction other than gripping teeth of the gripping jaw portions;
therefore when the clip member is in closed position, there is a rounded opening in between closed first and second jaw portions to provide a nonslip grip for rounded items, such as flag pole.
